(19) United States
(12) Patent Application Publication
(10) Pub. No.: US 2007/0221451 A1
(43) Pub. Date: Sep. 27, 2007

(54) Elevator Shaft Enclosure

(76) Inventors: Aitor Urteaga Martinez, Hernani Guipuzcoa (ES); Miguel Encabo Elizondo, Hernani Guipuzcoa (ES)

Correspondence Address: OSTROLENK FABER GERB & SOFFEN, 1180 AVENUE OF THE AMERICAS, NEW YORK, NY, 100368403, US

(21) Appl. No.: 11/568,672

(22) PCT Filed: Jul. 5, 2004
(86) PCT No.: PCT/ES04/00318

§ 371 Date: Nov. 3, 2006

(30) Foreign Application Priority Data
May 4, 2004 (ES) P200401067

(51) Int. Cl. B66B 13/24

(52) U.S. Cl. 187/336

(57) ABSTRACT

The present invention relates to an elevator shaft enclosure, formed by means of a series of punched plates which can be manually bent and cut so as to adapt them to the elevator shaft and to the dimensions of the door. The enclosure comprises on one of its sides at least two side closure plates, an upper plate and a lower plate, overlapping one another whereas in the upper part the enclosure comprises at least two other upper plates, one on the left and one on the right, also overlapping one another according to the width of the shaft to be covered.

### OBJECT OF THE INVENTION

The present invention relates to a metallic enclosure designed to cover the space existing between an elevator door and the construction shaft defined in the floor.

It is an object of the invention that the enclosure be arranged by means of a series of metal sheets that can be manually folded and cut in an easy manner at the installation site according to the dimensions of the space to be covered.

It is also an object of the invention that the sheets have a suitable geometry so as to allow their assembly by overlapping and that they be provided with means facilitating their fixing to the wall of the shaft and to the door of the elevator.

### BACKGROUND OF THE INVENTION

The installation of elevator floor doors is currently done in two phases. In the first phase, called the mechanical part, the doors are arranged in all the floors, anchoring them to the sides of the elevator shaft given that the entire face where the door is arranged is usually open. Once the doors are arranged, all the shaft openings of the face of the doors are closed: both sides, the lower area and upper area, then the plasterer levels the inner part of this face, and finally the electric installation for the doors is carried out.

The main problem when installing the enclosure is safety. The plasterer has to enter the elevator shaft, go up to the roof of the car and level the face of the door through the part of the shaft. To that end the plasterer must be trained in handling elevators during inspection.

Another problem relates to the dirt generated during installation work that penetrates the shaft to the elevator and can even damage some of the operating organs of the elevator.

There is also the drawback of having to carry out t he complete installation of the elevator in two phases, delaying the delivery deadline according to the longer duration of the brickwork jobs.

Some elevator installers completely close the shaft, thereby preventing the previously mentioned problems. Different methods are used:
Closing with polyisocyanurate: polyisocyanurate panels custom cut on site are used and they are joined to pieces of other panels by means of insulating tape. The joining of the enclosure to the wall and to the door is carried out by means of polyurethane foam. This solution has the problem of the lack of rigidity of the enclosure, because any perpendicular impact or force applied on the enclosure makes it detach from the wall or the door. The risk that this entails is very high because the visual impression of robustness does not correspond with reality and supporting any object or person on this enclosure may have serious consequences.
Closing with plasterboard: plasterboard is used to close the shaft. The assembly of these panels requires profiles which can be useful as a support for the plasterboard on the entire edge of the door and the wall, and these profiles must be measured and custom cut like the plasterboard panels. It is a solution which uses materials normally used in construction but they are usually assembled by masons, not elevator installers.
Closing with plate that is not punched: a plate is used to close the shaft. The measurements are taken floor by floor of all the shaft openings defined around the door to be closed, then all the pieces are custom cut, bent and identified. Finally they are welded on site to the door and screwed to the wall on the bent side. The logistics and on-site welding are the most negative aspects of this solution.

### DESCRIPTION OF THE INVENTION

The present invention consists of an elevator shaft enclosure formed by means of a series of punched plates which can be manually bent and cut so as to adapt them to the elevator shaft and to the dimensions of the door. It is a galvanized plate 1 mm thick that is easy to assemble and allows simple, safe, strong and cost-efficient installation.

The joining of the plate to the side of the shaft is carried out by means of a coach screw and the union of the door is carried by means of standard screws.

The dimensions to be closed normally vary a lot depending on the width of the shaft, the free passage, the type of door, the position of the door, height between floors; therefore the manufacture of parametric plates would be a rather impractical solution and would create very complicated logistics. Therefore the present invention proposes an enclosure consisting of a series of plates which are easily adapted to the dimensions to be closed.

The enclosure comprises on one of its sides at least two side closing plates, an upper plate and a lower plate, overlapping one another to a greater or lesser extent according to the height to be reached. Each of the side closing plates has on its upper and lower sides fringe-like cuts for manually bending the plate and facilitating the overlapping on the ground and with the upper plates.

In the upper part of the door, the enclosure comprises at least two other upper plates, one on the left and the other on the right, also overlapping as well to a greater or lesser extent according to the width of the shaft. Several pairs of upper plates could even be arranged according to the height between floors (the main floor is higher than the rest).

Both the side plates and the upper plates have extensions with reduced width, between 40 and 50 mm, and are bent as needed with a precision of, for example, +/−50 mm so as to adjust the transverse distance to the wall of the shaft.

In the event that the width of the extension does not coincide with the measurement required on site, 2 bevel-shaped bends can be made.

An L-shaped telescopic profile can be arranged between the pairs of plates, anchored to the sides of the shaft and useful as a support for the plates. This telescopic profile is the same one used to anchor the door at its upper part.

The lower part of the shaft is closed using two types of lower plates according to the free passage, each type used for several free passages and having extensions that can easily be cut. This plate is also bent on site, giving it a Z shape, resting on the door and anchored to the ground by means of coach screws.

### DESCRIPTION OF THE DRAWINGS

To complement the description being made and for the purpose of aiding to better understand the features of the invention according to a preferred practical embodiment thereof, a set of drawings is attached as an integral part of said description which show the following with an illustrative and non-limiting character:

FIG. 1 shows a frontal view of the elevator door in the shaft with no enclosure.

FIG. 2 shows a perspective view in which the elevator shaft enclosure installed around the door is observed.

FIG. 3 shows a side view of the enclosure in which the extensions of the side plate are observed.

FIG. 4 shows a frontal view of the upper plate before it is bent.

FIG. 5 shows a frontal view of the side plate before it is bent.

FIG. 6 shows a plan view of the lower plate before it is bent.

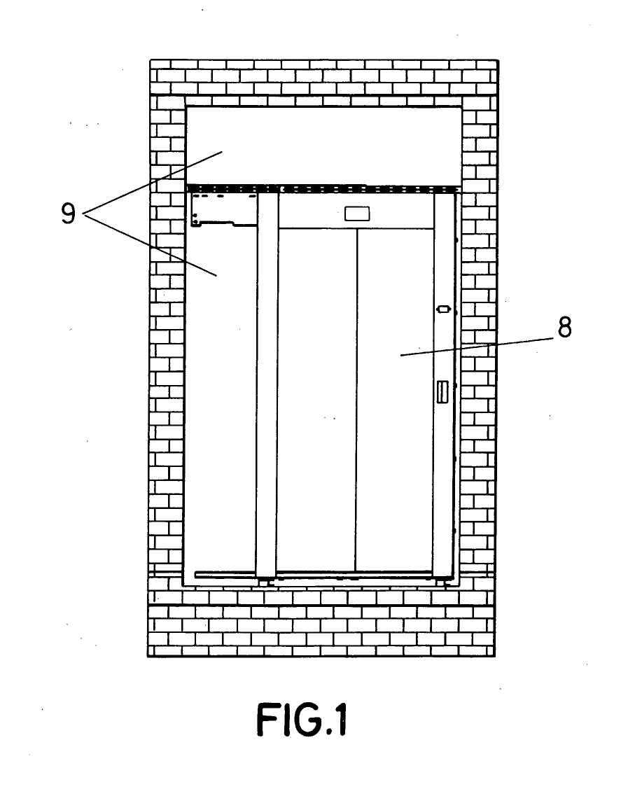

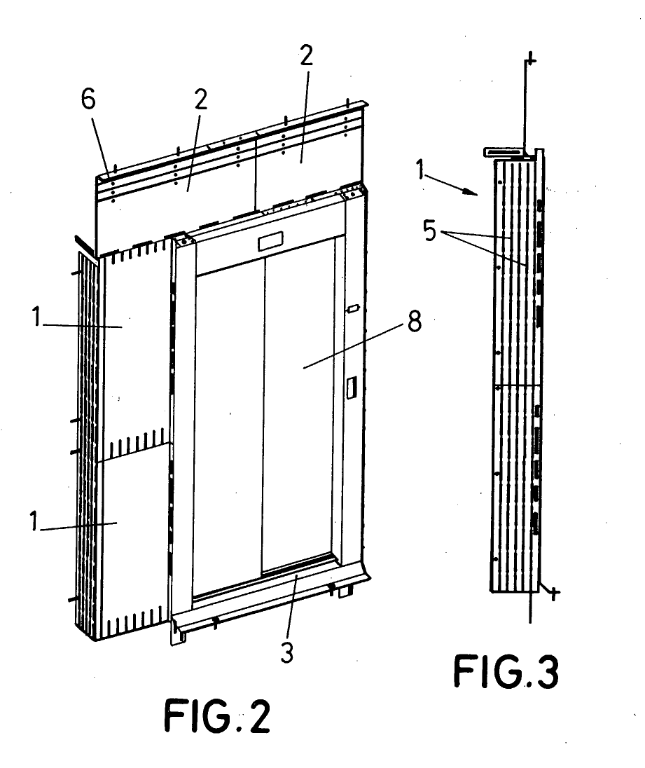

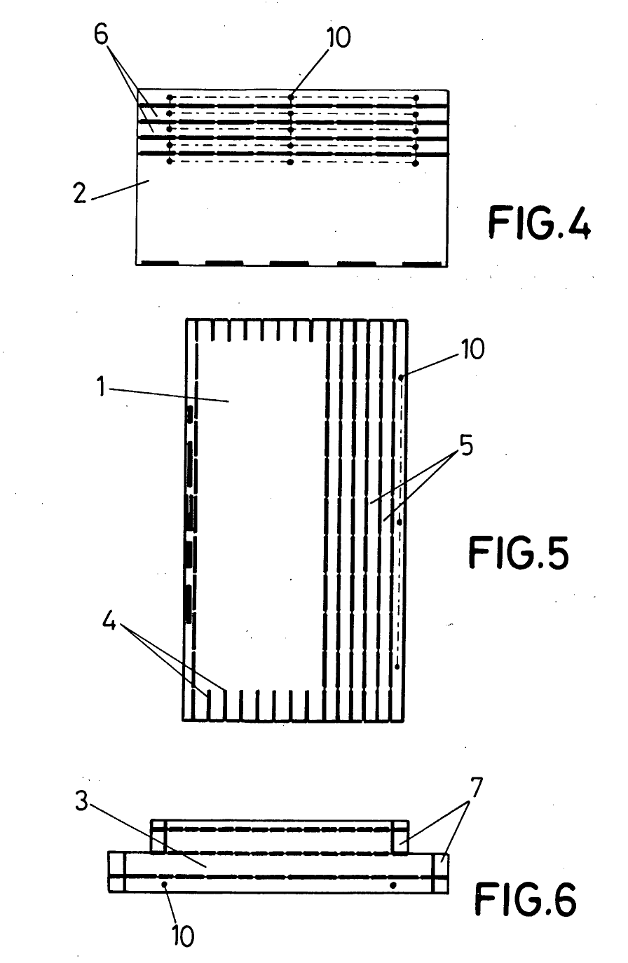

### PREFERRED EMBODIMENT OF THE INVENTION

The elevator shaft enclosure forming the object of the present invention comprises a structure formed from punched plates (1, 2, 3) with a reduced thickness which are manually bent and cut so as to adapt them to the space defined between the door (8) and the construction shaft (9) of the floor.

The structure comprises at least one side frame consisting of upper and lower side plates (1) overlapping one another according to the height of the side to be covered and having on their upper and lower sides fringe-like cuts (4) for manually bending the plate and facilitating its overlapping on the ground and with the upper plates.

The structure also comprises an upper frame consisting of at least a pair of left and right upper plates (2) overlapping one another according to the width of the space to be covered between the elevator door (8) and the side wall defining the construction shaft (9) of the floor.

These pairs of upper plates (2) can in turn overlap other pairs of upper plates (2) in the event that the height of each of said upper plates is not enough to cover the space between the door (8) and the upper wall defining the construction shaft (9) of the floor.

The structure finally comprises a lower plate (3) which is bent in a Z shape so as to be located between the base of the door (8) and the lower side of the construction shaft (9).

The side plates (1) have side extensions (5) which are bent and/or cut so as to adapt them to the distance of the side frame with respect to the wall limiting the construction shaft (9).

The upper plates (2) also consist of upper longitudinal extensions (6) which are bent and/or cut so as to be adapted to the distance of the upper frame with respect to the wall limiting the construction shaft (9).

The lower plate (3) has side extensions (7) which can be cut for adapting the width to the passage of the door (8).

It is contemplated that the described plates (1, 2, 3) have boreholes (10) so as to facilitate the passage of the corresponding fixing means connecting said plates to the wall defining the construction shaft and to the door.

1. An elevator shaft enclosure, of the type consisting of metallic parts covering the space defined on the floor between the door of the elevator and the walls limiting the construction shaft, wherein it comprises a structure formed by punched plates having reduced thickness that are manually bent and/or cut so as to adapt them to the space defined between the door and the construction shaft of the floor.

2. An elevator shaft enclosure according to claim 1, wherein it comprises at least one side frame consisting of upper and lower side plates overlapping one another according to the height of the side to be covered.

3. An elevator shaft enclosure according to claim 2, wherein the upper and lower side plates have on their upper and lower sides fringe-like cuts so as to manually bend the plate and facilitate overlapping it on the floor and with the upper plates.

4. An elevator shaft enclosure according to claim 1, wherein it comprises an upper frame consisting of at least one pair of left and right upper plates, overlapping one another according to the width of the space to be covered between the elevator door and the side wall defining the construction shaft of the floor.

5. An elevator shaft enclosure according to claim 4, wherein the pairs of upper plates overlap other pairs of upper plates in the event that the height of each one of said upper plates is not enough to cover the space between the door and the upper wall defining the construction shaft of the floor.

6. An elevator shaft enclosure according to claim 1, wherein it incorporates a lower plate which is bent in a Z shape for locating it between the base of the door and the lower side of the construction shaft.

7. An elevator shaft enclosure according to claim 1, wherein the side plates have side extensions which are bent and/or cut for adapting the distance of the side frame with respect to the wall limiting the construction shaft.

8. An elevator shaft enclosure according to claim 1, wherein the upper plates have upper longitudinal extensions which are bent and/or cut for adapting the distance of the upper frame with respect to the wall limiting the construction shaft.

9. An elevator shaft enclosure according to claim 1, wherein the lower plate consists of side extensions which are manually cut for adapting them in width to the passage of the door.

10. An elevator shaft enclosure according to claim 1, wherein the plates have boreholes so as to facilitate the passage of corresponding fixing means connecting said plates to the wall defining the construction shaft and to the door.
